(19) United States
(12) Patent Application Publication
(10) Pub. No.: US 2015/0324842 A1
(43) Pub. Date: Nov. 12, 2015

(54) Method of actively providing advertisement

(71) Applicant: YJEM CO., LTD., Seoul (KR)

(72) Inventor: Sang-Won YOON, Anyang-si (KR)

(21) Appl. No.: 14/691,617

(22) Filed: Apr. 21, 2015

(30) Foreign Application Priority Data
May 12, 2014 (KR) 10-2014-0056356

(51) Int. Cl. G06Q 30/02

(52) U.S. Cl. CPC G06Q 30/0251

(57) ABSTRACT

Disclosed is a method of actively providing an advertisement. The method includes: inputting a keyword by inputting information containing the keyword in a user application installed in a user terminal through an input function provided from an operating system of the user terminal; transmitting the keyword by transmitting the information containing the keyword to an advertisement providing server through an advertisement application installed in the user terminal independently from the user application, wherein the advertisement providing server communicates with the advertisement application separately from the user application; analyzing the keyword by analyzing the information containing the keyword by the advertisement providing server; determining an advertisement by the advertisement providing server, based on a result of analyzing the keyword; and displaying the determined advertisement on a display unit of the user terminal through the advertisement application.

### CROSS REFERENCE TO RELATED APPLICATION

This application claims the benefit of the Patent Korean Application No. 10-2014-0056356, filed on May 12, 2014, which is hereby incorporated by reference as if fully set forth herein.

### BACKGROUND OF THE INVENTION

1. Field of the Invention

One or more aspects of the present invention relate to a method of actively providing an advertisement via a user terminal, and more particularly, to a method of actively providing an advertisement by collecting information input via a user terminal by an advertisement providing server and transmitting an advertisement content matching a keyword of the collected information to the user terminal so as to output the advertisement content to a display of the user terminal, thereby enabling an advertiser to provide an advertisement related to user input.

2. Background Art

An effect of providing an advertisement through an Information and Technology (IT) device such as a computer, a tablet personal computer (PC), a notebook computer, a smartphone, etc. (hereinafter referred to as a ‘user terminal’) via an Internet network such as a wired/wireless communication network, a mobile network, etc. is high.

Use of user terminals such as a computer or a smartphone has become widespread. Most users carry user terminals accessible to the Internet with themselves at all times. The frequency of accessing the Internet is high. Thus, since advertisements using computers or smartphones can be exposed when users access the Internet, the frequency of exposure thereof is higher than those of advertisements using other existing media.

A messenger is one of very popular tools used when various IT devices such as a computer or a smartphone are used in the Internet. The messenger is a communication tool used when instant communication is established among two or more users via a network such as the Internet. The messenger has been gained a major status as one of electronic communication tools in the modern society. A real-time conversation using the messenger may make up for the weaknesses of email. Thus, the messenger and email are complementary to each other, similar to letters and telephone calls, and have become most important parts in Internet communication. An explosive growth in the market of IT devices such as a computer and a smartphone has definitely contributed to vitalizing an IT market, together with advancement in such messenger services. As the messenger has been introduced and become popular, IT devices are very popular.

According to this trend, creating various profits using a messenger application has attracted much attention as a major market. For example, a messenger application may be interworked with games or shopping or advertisements may be provided using the messenger application.

In general, in an advertising method using a messenger application, an advertisement is provided in a specific blank space in a service screen. However, most advertisements neither appeal to advertisement targets nor motivate the advertisement targets to view the advertisements. Thus, most advertisements are likely to be ignored by users. Also, since an advertisement of a product is provided to all users other than main target customers of the product due to insufficient information regarding users of a service to which the advertisement is exposed, costs for advertising the product increases and the effect of advertising the product decreases.

### SUMMARY OF THE INVENTION

One or more embodiments of the present invention include a method of actively providing an advertisement, in which an advertisement providing server collects information input via a user terminal and transmits an advertisement content matching a keyword of the collected information to the user terminal so as to display the advertisement content on a display of the user terminal, so that an advertiser may provide an advertisement related to user input to increase the efficiency of an advertisement and a user may improve the quality of his/her lift through the advertisement.

To achieve these objects, the present invention provides a method of actively providing an advertisement, the method comprising inputting a keyword by inputting information containing the keyword in a user application installed in a user terminal through an input function provided from an operating system of the user terminal, transmitting the keyword by transmitting the information containing the keyword to an advertisement providing server through an advertisement application installed in the user terminal independently from the user application, wherein the advertisement providing server communicates with the advertisement application separately from the user application, analyzing the keyword by analyzing the information containing the keyword by the advertisement providing server, determining an advertisement by the advertisement providing server, based on a result of analyzing the keyword; and displaying the determined advertisement on a display unit of the user terminal through the advertisement application.

The user application may comprise one of a messenger application, a social network service (SNS) application, an application with a bulletin board function, and an application with a search function.

The displaying of the advertisement may comprise displaying the advertisement in a popup form on an upper portion of a display region of the user application displayed on the display unit of the user terminal.

The information containing the keyword may be an input value which is input in real time through the input function provided from the operating system of the user terminal.

The analyzing of the keyword may comprise analyzing a product or a service related to the keyword.

The analyzing of the keyword may comprise further analyzing at least one among a user's location, sex, and age, and time zones and seasons when the user uses the user terminal.

The determining of the advertisement may comprise determining an advertisement by matching a product or a service analyzed in the analyzing of the keyword with at least one advertisement stored in the application server or the advertisement providing server.

The determining of the advertisement may comprise determining a plurality of advertisements assigned priority.

In the displaying of the advertisement, location of the displayed advertisement may be variable, and the advertisement is displayed in a blank space of the display region of the user application on the display unit of the user terminal.

In the displaying of the advertisement, if the advertisement may disappear from the display region of the display unit when a screen is scrolled by a user through the display unit, the advertisement is displayed again within the display region of the display unit.

In the displaying of the advertisement, the advertisement may be a hyperlinked text or image, wherein, when the text or image may be selected by a user, a hyperlinked web page or a multimedia content may be displayed.

The displaying of the advertisement may comprise displaying in the advertisement an amount of points to be saved for a user by an advertiser or an advertisement provider, wherein the points are available to exchange for a desired object in an offline or online site, and the method further comprising saving the points by transmitting information that the user satisfies a point saving condition to the advertisement providing server through the advertisement application when the user selects the advertisement assigned the points and views a web page linked to the advertisement or information regarding a displayed multimedia content for a predetermined time or more.

When in the determining of the advertisement, advertisements determined based on information which may contain a keyword and is input by a user within a predetermined time are the same, the displaying of the advertisement is skipped.

The saving of the points may be skipped when advertisements determined based on information which contains a keyword and may be input by a user within a predetermined time are the same in the determining of the advertisement.

An advertisement assigned lower priority may be displayed when advertisements determined based on information which contains a keyword and is input by a user within a predetermined time are the same in the determining of the advertisement.

When the advertisement displayed in the displaying of the advertisement may be touched by a user, selection mode icons are displayed, wherein the selection mode icons may comprise an icon for directly accessing a hyperlinked homepage, an icon for ending the user application and accessing the hyperlinked homepage and an icon for adding the hyperlinked homepage to a favorites list of a web surfing user application installed in the user terminal.

Advertisements displayed in the displaying of the advertisement may be accumulatively stored in a favorites list of a web surfing application installed in the user terminal or an advertisement storage box of the advertisement application.

### BRIEF DESCRIPTION OF THE DRAWINGS

FIG. 1 is a block diagram of a user terminal according to an exemplary embodiment of the present invention;

FIG. 2 is a block diagram of a system of a method of actively providing an advertisement according to an exemplary embodiment of the present invention;

FIG. 3 is a block diagram of a system including a display unit with an input unit, the system for performing a method of actively providing an advertisement according to another exemplary embodiment of the present invention;

FIG. 4 is a block diagram of a system including an application server that functions as an advertisement providing server, the system for performing a method of actively providing an advertisement according to an exemplary embodiment of the present invention;

FIG. 5 is a flowchart of a method of actively providing an advertisement according to an exemplary embodiment of the present invention;

FIG. 6 illustrates an advertisement formed after information is input by a user in a method of actively providing an advertisement according to an exemplary embodiment of the present invention;

FIG. 7 illustrates an advertisement formed by analyzing an input value in real time while information is input by a user in a method of actively providing an advertisement according to an exemplary embodiment of the present invention;

FIG. 8 illustrates a case in which a popup advertisement is displayed again in a display region of a display unit when the popup advertisement disappeared from the display region as messages are input, in a method of actively providing an advertisement according to an exemplary embodiment of the present invention;

FIG. 9 is a diagram illustrating a case in which an advertisement is provided using a location-based service of a user terminal in a method of actively providing an advertisement according to an exemplary embodiment of the present invention;

FIG. 10 is a diagram illustrating a case in which a hyperlinked site is moved to when a popup advertisement is selected by a user in a method of actively providing an advertisement according to an exemplary embodiment of the present invention;

FIG. 11 illustrates an advertisement video reproducing content displayed when a popup advertisement is selected by a user in a method of actively providing an advertisement according to an exemplary embodiment of the present invention;

FIG. 12 illustrates selection mode icons formed when a popup advertisement is selected by a user in a method of actively providing an advertisement according to an exemplary embodiment of the present invention; and

FIG. 13 illustrates a state in which an advertisement provided in a display region of a display unit is automatically removed after a predetermined time in a method of actively providing an advertisement according to an exemplary embodiment of the present invention.

### DETAILED DESCRIPTION

Hereinafter, exemplary embodiments of the present invention will be described in detail with reference to the accompanying drawings. The present invention may, however, be embodied in many different forms and should not be construed as limited to the embodiments set forth herein. Rather, these embodiments are provided so that this disclosure will be thorough and complete, and fully convey the scope of the invention to those skilled in the art. Throughout the specification, the same reference numbers may be used to denote similar components in various embodiments.

In the present disclosure, the term ‘user terminal’ should be understood as a concept including a mobile phone, a computer, a tablet personal computer (PC), a notebook computer, etc. The term ‘user terminal’ may be defined to include various devices that include a central processing unit (CPU), a display device, an input device, and a communication unit and that are capable of communicating with other terminals via a network.

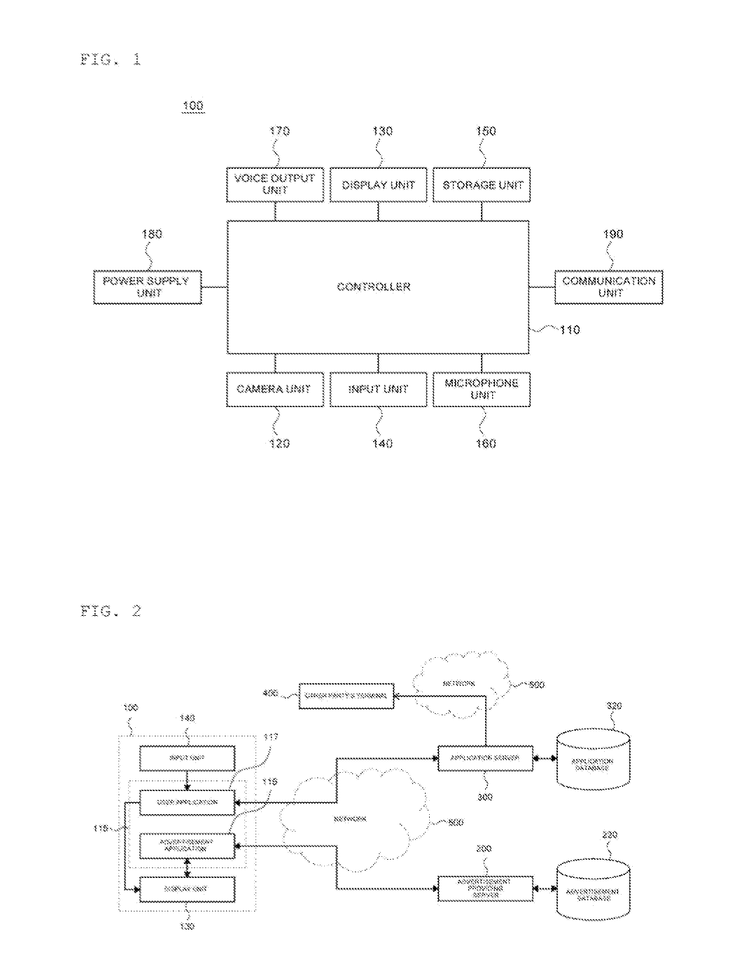

FIG. 1 is a block diagram of a user terminal 100 according to an exemplary embodiment of the present invention. Referring to FIG. 1, the user terminal 100 may include a controller 110, a camera unit 120, a display unit 130, an input unit 140, a storage unit 150, a microphone unit 160, a voice output unit 170, a power supply unit 180, a communication unit 190, etc. These elements may be connected to and controlled by the controller 110.

The controller 110 may control various elements of the user terminal 100 to operate according to a user command by using a kernel which is an application module included in a main memory device of the controller 110 to interact with various elements of the user terminal 100.

Here, the kernel may control access to various elements of the user terminal 100 while providing an application installed in the user terminal 100 with a simple standard interface for accessing various elements of the user terminal 100.

However, the elements illustrated FIG. 1 are not indispensable element. Thus, the user terminal 100 may further include other elements or include only some of the elements of FIG. 1. The elements of FIG. 1 will be described below.

The communication unit 190 may include at least one module for establishing wireless/wire communication between the user terminal 100 and a wireless/wire communication system or between a plurality of user terminals 100 via a network. For example, the communication unit 190 may include at least one among a broadcast receiving module, a mobile communication module, a wireless Internet module, a wire Internet module, a local area communication module, and a location information module.

The user terminal 100 may include a camera unit 120 and a microphone unit 160 to receive an audio signal or a video signal. The camera unit 120 may capture an image of an object and generate and process an image (such as a still image or a video) obtained using an image sensor in a video call mode or an image capturing mode. Images captured by the camera unit 120 may be displayed on the display unit 130. An image generated by the camera unit 120 may be stored in the storage unit 150 or transmitted to an external device via the communication unit 190. Two or more camera units 120 may be installed according to a user environment.

The microphone unit 160 may process electric voice data by receiving an external sound signal via a microphone in a call mode, a recording mode, a voice-recognition shooting mode, etc. In a call shooting mode, the processed voice data may be converted and output into a format to be transmitted to a mobile communication base station via the communication unit 190. In the microphone unit 160, various noise removing algorithms may be installed to remove noise generated during receiving of an external sound signal.

Through the input unit 140, a user may generate input data for controlling an operation of a terminal. The input unit 140 may include a keypad, a dome switch, a constant-pressure/electrostatic touch pad, a jog wheel, a jog switch, etc.

The display unit 130 may display or output information processed by the user terminal 100. For example, when the user terminal 100 is in the call shooting mode, the display unit 130 may display a user interface (UI) or a graphic user interface (GUI) related to a call. When the user terminal 100 is in a video-call shooting mode or a shooting mode for taking a photograph, the display unit 130 may display an image that is captured, generated and/or received, an UI, or a GUI. In general, the display unit 130 may include one of a liquid crystal display (LCD), a thin film transistor (TFT)-LCD, an organic light-emitting diode (OLED), and a flexible display.

Furthermore, according to the present embodiment, the display unit 130 may be a touch panel or a touch screen through which information and/or an image may be selected while the information and/or the image are displayed. For example, when the display unit 130 and a sensor that senses a touch operation (hereinafter referred to as a ‘touch sensor’) form a layer together (hereinafter referred to as a ‘touch screen’), the display unit 130 may be used not only an image output device but also an input device.

The touch sensor may be, for example, a touch film, a touch sheet, a touch pad, etc. The touch sensor may be configured to convert either a pressure applied to a specific location on the display unit 130 or a change in an electrostatic capacitance generated on a specific location on the display unit 130 into an electric input signal. The touch sensor may be configured to sense not only a touched location and area but also a pressure applied when the display unit 130 is touched. When a touch input is input using the touch sensor, a signal or signals corresponding to the touch input are transmitted to a touch controller (not shown). The touch controller may process the signal(s) and transmit data obtained by processing the signal(s) to the controller 110. Thus, the controller 110 may detect a touched region of the display unit 130, a manner in which the display unit 130 is touched, whether the touching of the display unit 130 is a single touch or a multi-touch), etc.

The voice output unit 170 may output audio data, which received from the communication unit 190 or stored in the storage unit 150, in a signal receiving mode, a call mode, a recording/shooting mode, a voice-recognition shooting mode, a broadcast-receiving shooting mode, etc. The voice output unit 170 may output a sound signal related to a function performed by the user terminal 100 (e.g., a signal ringtone, a message ringtone, etc.). The voice output unit 170 may include a receiver, a speaker, a buzzer, etc.

The storage unit 150 may store an application for performing processing and controlling by the controller 110 or temporarily store input/output data (e.g., a telephone book, messages, audio, still images, video images, etc.). As will be described below, the storage unit 150 may provide spaces for installing and processing various user applications (e.g., games, a messenger, etc.) installed in the user terminal 100.

In general, the controller 110 may control overall operations of the user terminal 100. For example, the controller 110 may perform controlling and processing related to a voice call, data communication, a video call, etc. The controller 110 may include a multimedia module (not shown) for reproducing multimedia contents. Also, the controller 110 may perform controlling and processing needed for various applications by performing functions of a central processing unit (CPU) 115, including the storage unit 150 in which various applications as described above are installed.

The power supply unit 180 may supply power to operate various elements of the user terminal 100 from an external power source or an internal power source, under control of the controller 110.

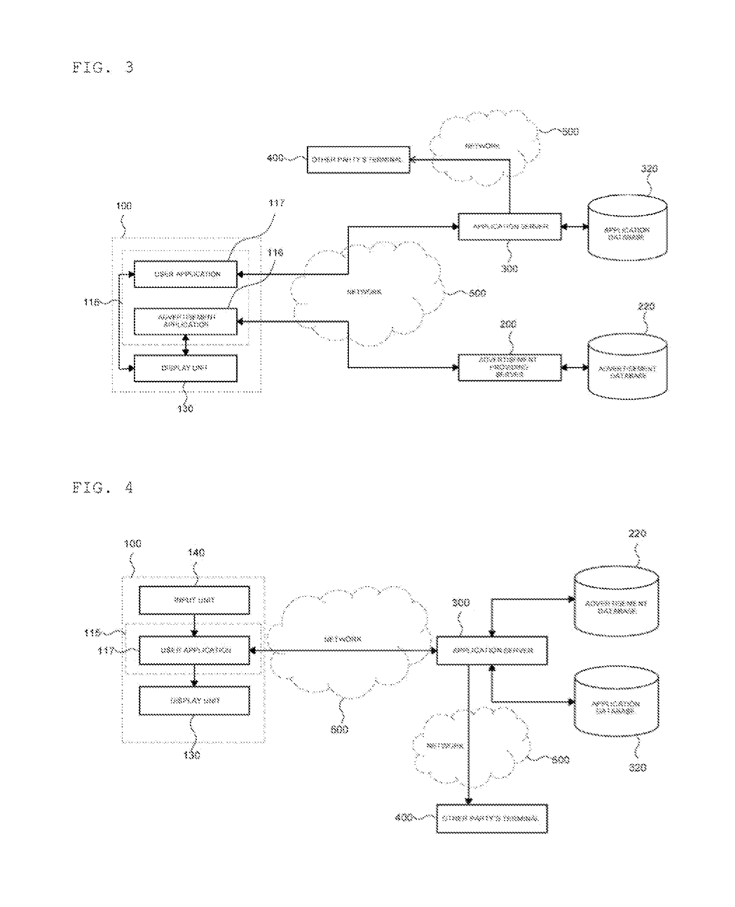

FIG. 2 is a block diagram of a system of a method of actively providing an advertisement according to an exemplary embodiment of the present invention.

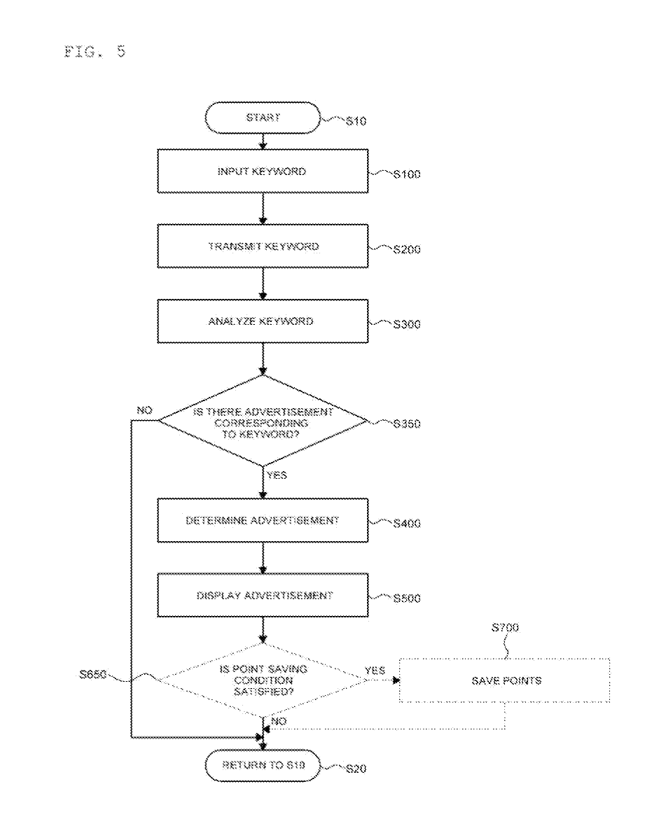

In embodiments which will be described with reference to FIGS. 2 and 3 below, cases in which an advertisement is actively provided by installing an additional advertisement application 116 separately from a user application 117 installed in a user terminal 100 will be described.

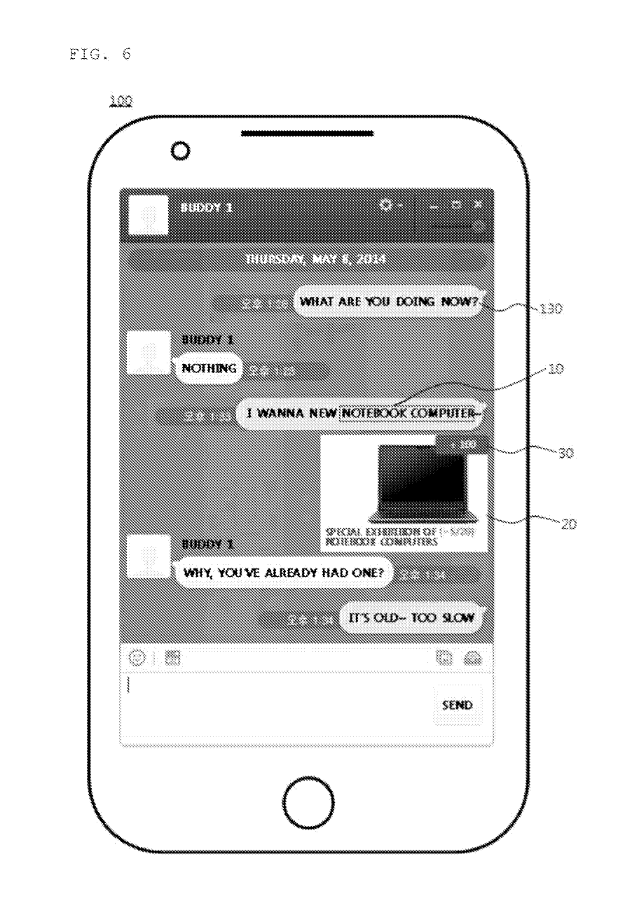

However, an advertisement may be provided using the user application 117 (such as a messenger) including an advertising module without installing the additional advertisement application 116, as will be described with reference to FIG. 4 below.

Referring to FIGS. 2 and 3, information is input for communication, etc. via an input unit 140 of the user terminal 100. The input information may include a keyword related to an advertisement.

The input information such as a text may be transmitted to an advertisement providing server 200. The advertisement providing server 200 may extract the keyword from the information, analyze the extracted keyword and a keyword extracted from an advertisement content stored in an advertisement database 220, and transmit an advertisement content matching a result of analyzing the keywords to the user terminal 100. The advertisement content transmitted to the user terminal 100 may be output to a display unit 130 of the user terminal 100.

The input unit 140 of the user terminal 100 may be integrally formed with the display unit 130. When the user terminal 100 includes the display unit 130 which is a touch panel or a touch screen, similar to a smartphone or a tablet PC, the display unit 130 of the user terminal 100 may perform both an output function and an input function. FIG. 3 illustrates that the display unit 130 is capable of performing both an input function and an output function. Thus, it is assumed that the display unit 130 which will be described below is capable of performing both the output function and the input function.

The user application 117 may be a messenger application, a social network service (SNS) application, an application with a bulletin board function, or an application with a search function. However, the user application 117 according to an embodiment of the present invention is not limited to the above applications, and any other applications may be used as the user application 117 provided that they are capable of receiving and outputting an advertisement content from the advertisement providing server 200 or an application server 300 that may communicate with the user terminal 100 based on information input via the user terminal 100 via a network.

Also, if the user application 117 is a messenger application, when information for communication (i.e., a signal or information that is input through a default input application provided from an operating system (OS)) is input via the input unit 140 of the user terminal 100, the input information is transmitted to the application server 300 while being collected by the advertisement application 116. Thus, the input information may be stored in an application database 320 and transmitted to and displayed on the other party's terminal 400 and the user terminal 100. Thus, the user application 117 may perform not only a communication function which is an original function thereof but also an advertisement providing function.

The information (i.e., the signal input using the default input application provided from the OS) which is input to the user application 117 via the input unit 140 of the user terminal 100 may be input to use only the user application 117 according to a user's intention.

Thus, in order to collect information input to the user application 117 through the advertisement application 116, a platform of the OS or the like may permit the information input via the input unit 140 (which provides input information to the user application 117) to be shared with other applications, so that the input information may be also provided to the advertisement application 116.

That is, in order to collect information input to the user application 117 while the user application 117 is used, the platform of the OS or the like may permit other applications to access a signal input via the input unit 140, i.e., a signal input using the default input application of the OS.

Even if the platform of the OS or the like permits to share information input to the input unit 140, the advertisement application 117 may be installed based on a precondition that approval should be obtained from a user or the like to collect information input via the input unit 140.

Otherwise, information input to the user application 117 via the input unit 140 of the user terminal 100 may be collected using a software input application installed in the user terminal 100 (e.g., a software keypad application, etc.) other than the default input application provided from the OS for driving the user terminal 100.

The software input application may be an application to be mapped to the default input application provided from the OS without changing the platform or the kernel of the OS or the like.

Thus, information input using the software input application may be transmitted to not only the user application 117 via the default input application of the OS but also the advertisement application 116 to analyze a keyword.

When the software input application is installed in the user terminal 100, the soft input application may request a user of the user terminal 100 to provide approval for information regarding an application installed in the user terminal 100, as the user application 117 and the advertisement application 116. When the soft input application is given the approval, from the user, the software input application which is additionally installed may be used as an input unit in the user terminal 100.

The software input application and the advertisement application 116 may be provided in the form of one application. In this case, a process of obtaining the approval from the user may be simplified.

Thus, a user may input information to the user application 117 through the additionally installed software input application. The input information may be provided to the advertisement application 116. When the user terminal 100 is used, the information input to the user application 117 through the additionally installed software input application as an input unit may be shared with or collected by the advertisement application 116. Thus, even if the kernel of the OS or the like is not open, the advertisement application 116 may collect the information, which is input to the user application 117 to be used for another application, and use the information to actively provide an advertisement.

The user terminal 100, the advertisement providing server 200, the application server 300, and the other party's terminal 400 may be connected via a network 500 such as the Internet, an intranet, a wire/wireless communication network, a mobile communication network, etc.

Various embodiments of a system that performs a method of actively providing an advertisement based on information input via the input unit 140 of the user terminal 100 according to an embodiment of the present invention will be described in detail below.

The advertisement providing server 200 may permit the user terminal 100 to access thereto via the Internet such as a wire/wireless communication network, a mobile communication network, etc., receive information for communication from the user terminal 100, and transmit an advertisement content to the user terminal 100 so that the advertisement content may be output to the display unit 130. The advertisement providing server 200 or the advertisement database 220 may store the advertisement content, and store matching data matching conversation information and the advertisement content.

The application server 300 may communicate with the user terminal 100 via the Internet, such as a wire/wireless communication network, a mobile communication network, etc., so as to drive a user application installed in the user terminal 100.

When the user application is a messenger application, the application server 300 may be a server that may enable the user terminal 100 to communicate with at least one other party's terminal 400.

The user terminal 100 may transmit information input thereto for communication to the other party's terminal 400 to output the information to a display of the other party's terminal 400, and receive information from the other party's terminal 400 and output the received information to the display unit 130 thereof.

The user terminal 100 may be a smart device such as a smartphone or a PC but is not limited thereto. Various types of terminals may be used as the user terminal 100, provided that the advertisement application 116 and/or the user application 117 may be installed therein and the various types of terminals are capable of receiving and outputting an advertisement content from the advertisement providing server 200 or the application server 300 via the Internet, based on input information.

The advertisement application 116 may be installed in the user terminal 100 according to an embodiment of the present invention. A user may input information via the input unit 140 of the user terminal 100. The input information may be collected by the advertisement application 116 and transmitted to the advertisement providing server 200. Then, a keyword may be extracted from the input information and analyzed by comparing it with a keyword extracted from an advertisement content stored in the advertisement database 220. Then, an advertisement content matching a result of analyzing the keyword is transmitted to the advertisement application 116 of the user terminal 100 to be output to the display unit 130.

That an advertisement is output to the display unit 130 may be understood as displaying the advertisement or the content of the advertisement in a popup form on a display region of an user application

Also, an advertisement content output from the user terminal 100 may be stored in a favorites list of the user application 117 or an advertisement storage box of the advertisement application 116.

The user application 117 may be installed in the user terminal 100 according to an embodiment of the present invention. A user may communicate with another user using messages, images, videos, documents, multimedia content, etc. through the user application 117 installed in the user terminal 100.

The multimedia contents may include at least one among videos, pictures, characters, voice, flash emoticons, and flash animation.

In detail, an application server 300 of FIG. 4 may perform a keyword analysis using an advertisement database 220, unlike in the embodiments described above with reference to FIGS. 2 and 3.

A user application 117 installed in a user terminal 100 may collect information input for communication via an input unit 140, and transmit the information to the application server 300.

The transmitted information may be provided to the application database 320, and a keyword may be extracted from the information while the information is transmitted to the other party's terminal 400 and the user terminal 100. Then, the keyword is analyzed by matching it with a keyword of an advertisement content stored in the advertisement database 220, and an advertisement content to be provided to a user may be determined. Then, the advertisement content may be transmitted to the user terminal 100 and output to the user application 117 via a display unit 130 of the user terminal 100.

In this case, the user application 117 may be set to perform or include a function of the advertisement application 116 through prior consultation between the manufacturer/operator of the advertisement application 116 and the manufacturer/operator of the user application 117. Since the advertisement application 116 is omitted, the advertisement providing server 200 that communicates with the advertisement application 116 may be also omitted. Thus, the advertisement database 220 may perform a keyword analysis while being connected to the application server 300.

In the above embodiment, the advertisement application 116 need not be additionally installed in the user terminal 100 and the user application 117 also functions as the advertisement application 116. Thus, the entire system may be simplified. Furthermore, user inconvenience caused when arbitration is set through the kernel or a software input application is additionally installed to collect information input to the user application 116 may be avoided.

In the embodiments described above with reference to FIGS. 2 to 4, methods of actively providing an advertisement to a user in both a case in which a user application installed in a user terminal does not include an advertisement providing function and an advertisement application is additionally installed and a case in which an advertisement providing module is installed have been described above.

In the former case, the advertisement application should be additionally installed in the user terminal separately from the user application. In this case, a point saving function or the like which will be described below may be used to induce a user to install the advertisement application.

In the latter case, the point saving function may be also used to boost an advertising function. When a user does not want the advertising function, this function may be deactivated not to interrupt use of the user application.

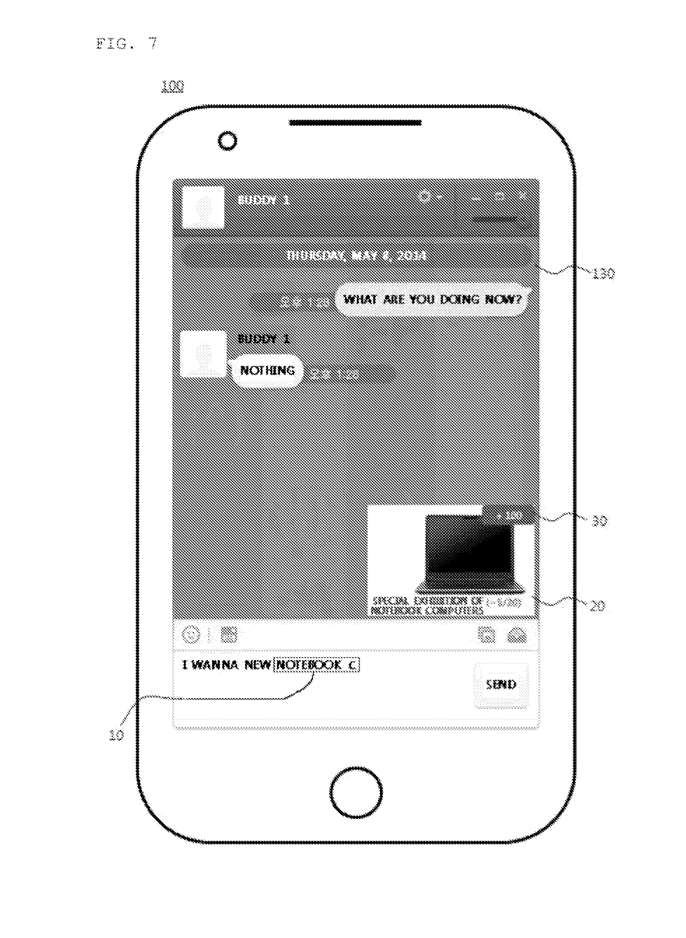

FIG. 5 is a flowchart of a method of actively providing an advertisement using a user terminal as described above, according to an exemplary embodiment of the present invention. Referring to FIG. 5, the method may include arbitrarily inputting a keyword (e.g., a text, i.e., an advertisement keyword) by a user via an input unit of the user terminal (operation S100), transmitting the input keyword to a server (operation S200), analyzing the transmitted keyword by an advertisement providing server (operation S300), and determining an advertisement based on a result of analyzing the keyword (operation S400). The server may be an advertisement providing server or a messenger server according to the above embodiments.

The inputting of the keyword (operation S100) may be performed using an input function of the user application installed in the user terminal or an input function provided from an OS of the user terminal.

In most user applications, a process of inputting a specific text may be performed using the input function provided from the OS of the user terminal.

Thus, even if the user application does not support the advertisement providing function, the advertisement application may transmit a text input through the input function provided from the OS to an advertisement server so as to perform the analyzing of the keyword (operation S300) and the determining of the advertisement (operation S400). Then, the determined advertisement may be transmitted to the user terminal to display the advertisement through the advertisement application (operation S500).

Operations S200 to S500 may be selectively activated or deactivated in the user application or the advertisement application. That is, the advertisement providing function may be activated or blocked according to a user's selection.

According to an embodiment of the present invention, in the displaying of the advertisement (operation S500), the advertisement may be displayed on the display unit 130 of the user terminal 100, after the inputting of the keyword (operation S100) is performed using the input function of the user application 117 installed in the user terminal 100 and then the transmitting of the keyword (operation S200), the analyzing of the keyword (operation S300), and the determining of the advertisement (operation S400) are sequentially performed.

After the displaying of the advertisement (operation S500), whether points are to be saved may be determined (operation S650).

The method of actively providing an advertisement according to an embodiment of the present invention may further include saving points corresponding to an amount of money, which is determined beforehand by an advertiser and/or an advertising company, for a user when the user view the advertisement content 20 for a predetermined time (operation S700).

In this case, when the points are saved for the user, the user application 117 or the advertisement application 116 may transmit information that the user satisfied a point saving condition to the application server 300 or the advertisement providing server 200. The saved points may be used to exchange for a desired object in an online/offline store. The amount of the points may be indicated in the advertisement content 20 displayed on the display unit 130.

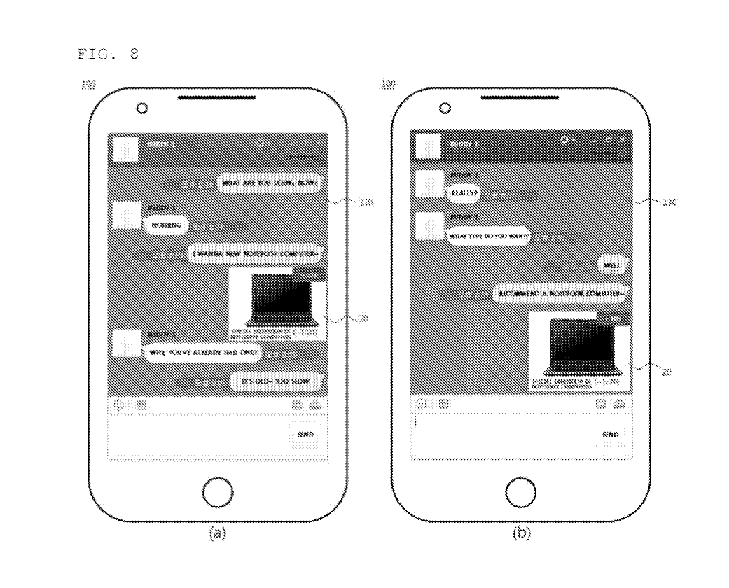

FIG. 6 illustrates an advertisement formed on a display unit 130 after information is input by a user according to an exemplary embodiment of the present invention. FIG. 7 illustrates an advertisement formed by analyzing a keyword 10 in real time while the keyword 10 is input by a user in a method of actively providing an advertisement according to an exemplary embodiment of the present invention.

In the embodiment of FIG. 6, the keyword 10 is transmitted through a user application or an advertisement application in a state in which the inputting of the keyword 10 ends, and then an advertisement content 20 is displayed. In contrast, in the embodiment of FIG. 7, a part of a sentence is transmitted, a ‘notebook computer’ included in the part of the sentence is identified as a keyword 10, and an advertisement content 20 is displayed while the keyword 10 is input, for example, in a state in which the sentence is not completely input in a messenger application.

In the embodiment of FIG. 7, in the displaying of the advertisement (operation S500), the advertisement is displayed on the display unit 130 of the user terminal 100 by transmitting the keyword 10, which is being input, in real time (operation S200), analyzing the keyword 10 (operation S300), and determining the advertisement (operation S400), while the inputting of the keyword (operation S100) is performed using an input function of an OS installed beforehand in the user terminal 100.

That is, even before a text is completely input and transmitted to the application server through the user application, the user application or the advertisement application may transmit a keyword that was input while the text is input so to analyze the keyword and determine the advertisement, thereby improving the responsiveness of the advertisement.

That is, if the length of a message to be input is long during use of the user application such as a messenger, the user application or the advertisement application may transmit and analyze the message and provide an advertisement when a predetermined time elapses or a predetermined condition is satisfied even before the message is completely input, thereby improving the responsiveness of the advertisement.

In this case, when the user application is a messenger application, advertisements may be set to be serviced to only users who input a keyword or to be exposed to all users who use the same application.

In the analyzing of the keyword (operation S300), a product or a service related to the keyword 10 may be analyzed. The determining of the advertisement (operation S400) may performed by determining the advertisement by matching the analyzed product or service with at least one advertisement stored in the application server 300 or the advertisement providing server 200. In the determining of the advertisement (operation S400), a plurality of advertisements assigned priority may be determined.

FIGS. 6 and 7 illustrate cases in which the keyword 10 is a ‘notebook computer’ and the advertisement content 20 is also an advertisement related to notebook computers. However, even if matching is not exactly performed, a list of products or services suggested by the keyword 10 may be detected through a keyword analysis, whether there is an advertisement related to the list of products or services may be determined to provide an advertisement assigned priority.

Users who have a conversation though a user application such as a messenger are likely to repeatedly input the same keyword in a plurality of sentences. Thus, when in the determining of the advertisement (operation S400), advertisements determined based on the keyword 10 input by a user within a predetermined time are the same, the displaying of the advertisement (operation S500) may be skipped. That is, the displaying of the advertisement (operation S500) may be skipped when in the determining of the advertisement (operation S400), an advertisement content corresponding to the same keyword 10 as the advertisement content 20 is determined within a predetermined time after the advertisement content 20 is displayed on the user terminal 100.

In the determining of the advertisement (operation S400), when advertisements determined based on the keyword 10 input by a user within a predetermined time are the same, a lower-priority advertisement may be displayed. That is, when the same keyword 10 is repeatedly input by the user within the predetermined time, only a lower-priority keyword 10 may be analyzed and displayed on the display unit 130 of the user terminal 100.

In the embodiments of FIGS. 6 and 7, when the keyword 10 is a ‘notebook computer’, the advertisement content 20 may be an advertisement content related to a product with functions similar to those of the notebook computer (e.g., a tablet PC, a smartphone, etc.) or a service thereof.

In the displaying of the advertisement (operation S500), the advertisement content 20 may be displayed in a text or popup form on an upper blank space of a display region of the user application 117 displayed on the display unit 130 of the user terminal 100. The location of the displayed advertisement content 20 may be changed when the display unit 130 is touched by a user, when the user terminal 100 is tilted, or when the advertisement content 20 is intentionally dragged by the user. In the embodiments of FIGS. 6 and 7, the advertisement content 20 is displayed in a blank space of the user application 117 displayed on the display region of the display unit 130 of the user terminal 100.

The advertisement content 20 may include a point icon 30 to indicate an amount of points to be saved for the user. As illustrated in FIG. 5, when points are saved for the user through the determining of whether points are to be saved (operation S650) and the saving of the points (operation S700), points corresponding to the point icon 30 may be saved to be used at a later time.

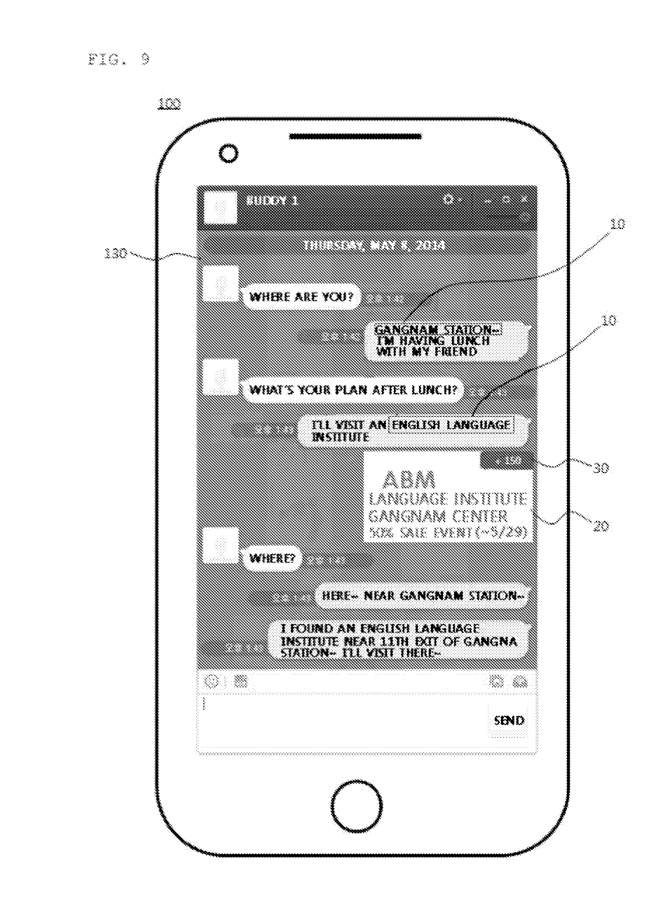

FIG. 8 illustrates a case in which a popup advertisement is displayed again in a display region of a display unit 130 of a user terminal 100 when the popup advertisement disappeared from the display region as messages are input, in a method of actively providing an advertisement according to an exemplary embodiment of the present invention.

When an advertisement content 20 displayed on the display region of the display unit 130 disappears as a screen is scrolled or as a current screen is switched to another screen, the location of the advertisement content 20 may be changed to be displayed again in the display region of the display unit 130.

In the user application 117 such as a messenger, a conversation window goes downward as the conversation continues and previous messages disappear from the display region of the user application 117 to display new messages.

When the advertisement content 20 displayed on the display unit 130 of the user terminal 100 goes upward to disappear from the display region of the user application 117 by newly input messages in the user application 117, the advertisement content 20 may be set to be automatically displayed again in the display region of the display unit 130. In this case, the advertisement content 20 may be displayed again in a blank space in the display region of the display nit 130.

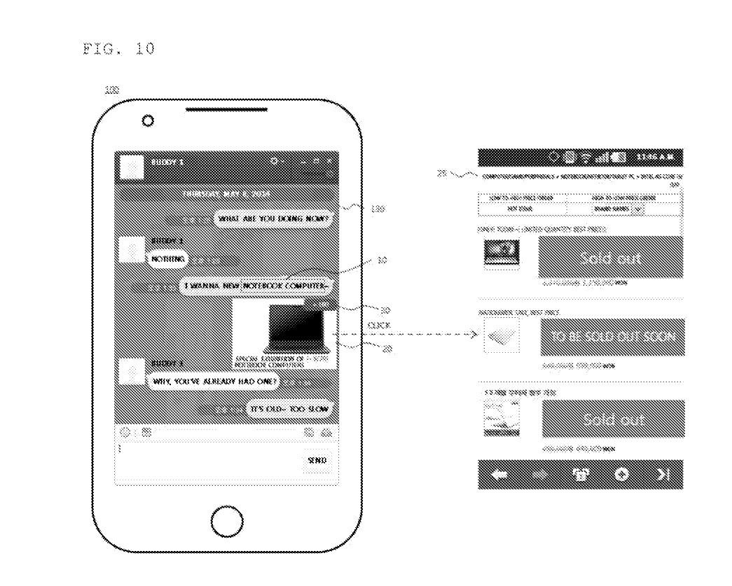

FIG. 9 is a diagram illustrating a case in which an advertisement is provided using a location-based service of a user terminal 100, in a method of actively providing an advertisement according to an exemplary embodiment of the present invention.

A location-based service may be used to appropriately provide the user terminal 100 with an advertisement according to a user's location. Referring to FIG. 9, an advertisement content 20 is displayed on a display unit 130 of the user terminal 100 using the location-based service of the user terminal 100.

When information is input via the input unit 140 of the user terminal 100 using the location-based service and the analyzing of the keyword (operation S300) is performed on the input information, the location of the user terminal 100 or the like is analyzed through a global positioning system (GPS), a communication network, or the like, together with a keyword 10 included in the input information. In this case, the advertisement content 20 displayed on the user terminal may be related to a product or a service that may be provided within a predetermined distance from a user of the user terminal 100.

For example, as illustrated in FIG. 9, when keywords ‘Gangnam Station’ and ‘English conversation’ input by a user are transmitted and analyzed, an user application or an advertisement application may extract a list of advertisements related to ‘English conversation’ based on ‘Gangnam Station’, and display the advertisement content 20 related to services provided from English language institutes located at Gangnam Station.

A user may set the controller 110 of the user terminal. 100 to or not to use the location-based service. Location information of the user terminal 100 provided from the location-based service may be provided via the communication unit 190 that controls a GPS of the user terminal 100 or a communication network, and the advertisement providing server 200 and/or a messenger providing server may be connected to the communication unit 190 of the user terminal 100 via a wireless/wire communication network so as to receive the location information of the user terminal 100.

That is, as described above, an advertisement is provided to a user by communicating with the user to determine a user's matters of interest. Thus, the effect of the advertisement may be maximized and desired information may be effectively provided to the user.

Also, in the analyzing of the keyword (operation S300), not only the location of a user but also the user's sex and age, and time zones and seasons when the user uses the user terminal 100 may be analyzed. Thus, the advertisement content 20 may be more useful to the user.

The user's sex and age and the time zones and seasons when the user uses the user terminal 100 may be reflected in various advertisement determination conditions stored in the advertisement database 220, and may help more exactly determine the user's matters of interest.

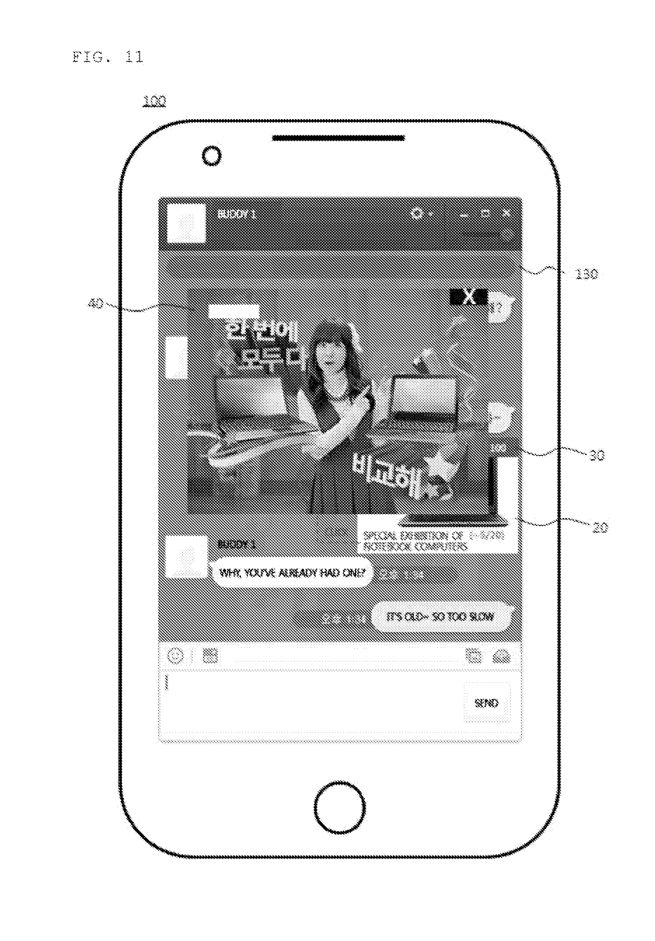

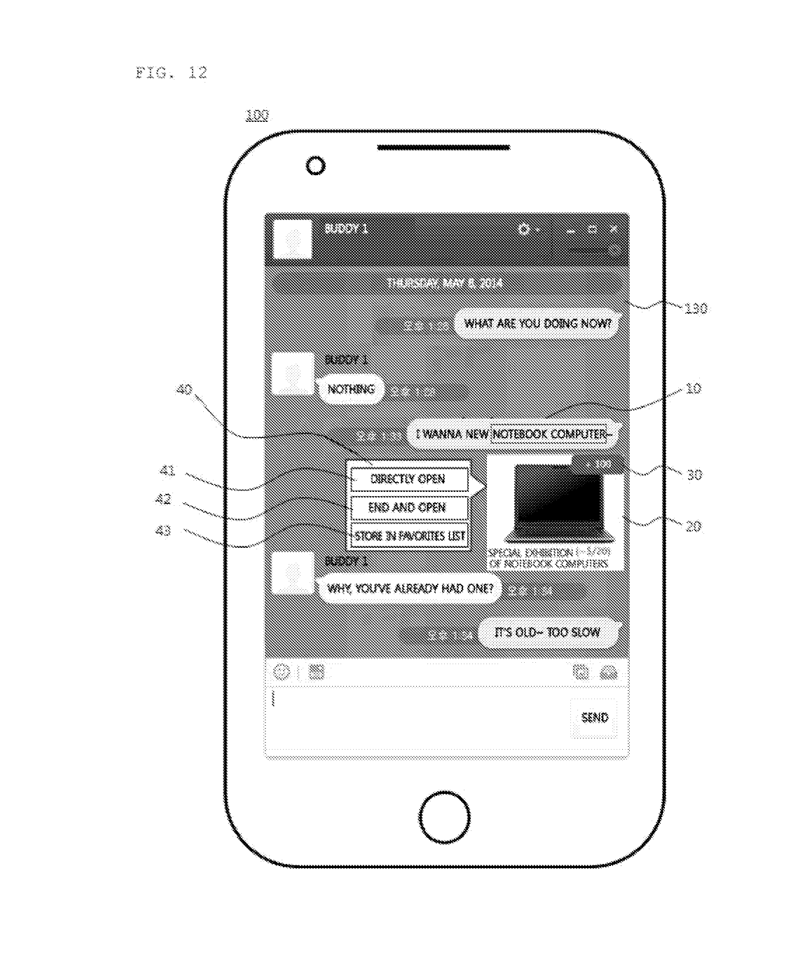

FIG. 10 is a diagram illustrating a case in which a hyperlinked site is moved to when a popup advertisement is selected by a user, in a method of actively providing an advertisement according to an exemplary embodiment of the present invention. FIG. 11 illustrates an advertisement video reproducing content displayed when a popup advertisement is selected by a user in a method of actively providing an advertisement according to an exemplary embodiment of the present invention.

Referring to FIG. 10, when a user selects an advertisement content 20 displayed on a display unit 130 of a user terminal 100, a screen of a web page 25 linked to the advertisement content 20 is displayed on the display unit 130. The web page 25 linked to the advertisement content 20 may be set to be accessible by the user when the user selects the advertisement content 20.

Thus, an application such as a web browser installed in the user terminal 100 may be driven to display the web page 25 linked to the advertisement content 20 when the advertisement content 20 is selected.

Also, in a method of actively providing an advertisement according to an embodiment of the invention, when a user views information contained in the web page 25 linked to the advertisement content 20 for a predetermined time, a predetermined amount of points determined beforehand by an advertiser and/or an advertising company may be saved for the user.

Referring to FIG. 11, when a user selects an advertisement content 20 displayed on a display unit 130 of a user terminal 100, a multimedia content 40 may be displayed on a blank space of a display region of the display unit 130. The multimedia content 40 may include at least one among a video, a picture, characters, voice, a flash emoticon, and flash animation. Information regarding the advertisement content 20 may be viewed within a display region of the user application 117 while the user application 117 is used.

The multimedia content 40 may be embodied using an application layer or an embedded web-view. When the multimedia content 40 is displayed and viewed for a predetermined time, a predetermined amount of points determined beforehand by an advertiser and/or an advertising company may be saved for a user.

However, a time period may be determined beforehand or advertisements may be compared so that points or the like may be prevented from being redundantly saved when the same advertisement is repeatedly viewed for the determined time period, thereby improving the efficiency of advertisements. That is, an application may be set such that points are not saved again even when the same advertisement is repeatedly viewed for a predetermined time or the same advertisement is not displayed.

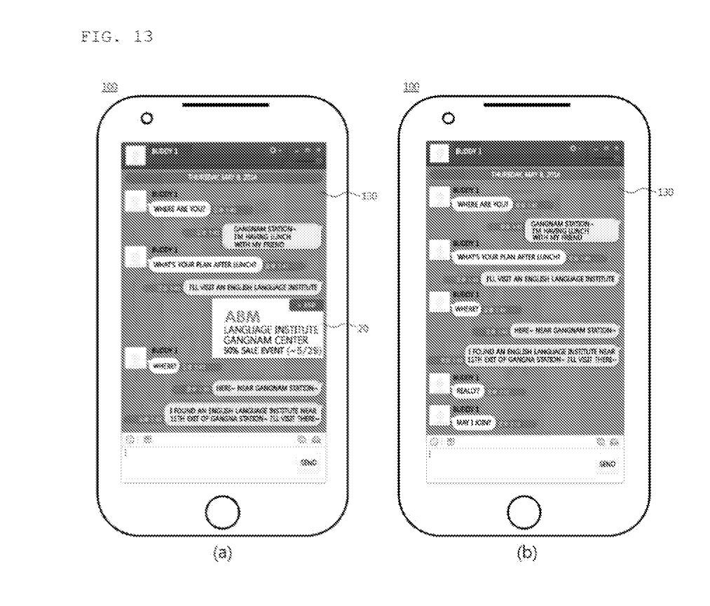

FIG. 12 illustrates selection mode icons formed when a popup advertisement is clicked by a user in a method of actively providing an advertisement according to an exemplary embodiment of the present invention.

When an advertisement content 20 displayed on a display unit 130 of a user terminal 100 is selected, selection mode icons 40 may be displayed near the displayed advertisement content 20 so that a user may select an option to view an advertisement.

Referring to FIG. 12, the selection mode icons 40 include an ‘directly open’ icon 41 for directly viewing advertisement information of the advertisement content 20, an ‘end and open’ icon 42 for displaying the advertisement information of the advertisement content 20 after the user application 117 that is being executed is ended, and an ‘add to favorites list’ icon 43 for adding the advertisement content 20 to a favorites list. Thus, an advertisement may be provided to users who are interested in the advertisement without interrupting use of a user application.

Thus, when the ‘directly open’ icon 41 is selected, an additional browser may be directly executed to display an advertisement or a multimedia content may be directly viewed. When the ‘end and open’ icon 42 is selected, an additional browser may be executed to display an advertisement or an advertisement may be provided to view a multimedia content, after a user application such as a messenger is ended. When the ‘add to favorites list’ icon 43 is selected, an Internet uniform resource locator (URL) related to the advertisement content 20 or the like may be stored in a favorites list of an additional web browser application.

FIG. 13 illustrates a state in which an advertisement provided in a display region of a display unit is automatically removed after a predetermined time in a method of actively providing an advertisement according to an exemplary embodiment of the present invention.

Referring to FIG. 13, an advertisement content 20 displayed on a display unit 130 of a user terminal 100 may be automatically removed from the display unit 130 a predetermined time after the advertisement content 20 is displayed on the display unit 130. A duration for which the advertisement content 20 is displayed on the display unit 130 may be determined beforehand by an advertiser and an advertisement providing company that provides the advertisement content 20 and/or the application providing company. Thus, a duration for which an advertisement is to be displayed on a display region of a user application may be minimized to minimize interruption in use of the user application and maximize the effect of causing a user's interest.

A user application or an advertisement application may be configured to include an additional advertisement storage box or the like, so that users may view previous advertisements. Also, when a displayed advertisement is displayed in a web page through a web surfing application, the displayed advertisement may be stored in a favorites list that the web surfing application provides.

According to the one or more of the above embodiments, in a method of actively providing an advertisement, an advertisement providing server collects information input from a user terminal and transmit an advertisement content matching a keyword of the collected input information to the user terminal so that the advertisement content may be output to a display of the user terminal. Thus, a user's interest in advertisements may be increased by collecting information regarding a user's matters of interest while focusing on the user's conversation, unlike in a method of indiscriminately exposing advertisements via user terminals according to the related art. Thus, user convenience may be improved and an advertiser may create high profits by increasing the effect of advertisements.

Also, in a method of actively providing an advertisement according to an embodiment of the present invention, some of profits obtained through advertisements that an advertiser provides may be returned to users who view the advertisements so as to increase the users' desire to view the advertisements, thereby contributing to the advancement of the advertisement industry.

Although the present invention has been described above with reference to the exemplary embodiments thereof, it would be understood by those skilled in the art that various changes and modifications may be made without departing from the technical conception and essential features of the present invention. Thus, it is clear that all modifications are included in the technical scope of the present invention as long as they include the components as claimed in the claims of the present invention.

What is claimed is:

1. A method of actively providing an advertisement, the method comprising: inputting a keyword by inputting information containing the keyword in a user application installed in a user terminal through an input function provided from an operating system of the user terminal; transmitting the keyword by transmitting the information containing the keyword to an advertisement providing server through an advertisement application installed in the user terminal independently from the user application, wherein the advertisement providing server communicates with the advertisement application separately from the user application; analyzing the keyword by analyzing the information containing the keyword by the advertisement providing server; determining an advertisement by the advertisement providing server, based on a result of analyzing the keyword; and displaying the determined advertisement on a display unit of the user terminal through the advertisement application.

2. The method of claim 1, wherein the user application comprises one of a messenger application, a social network service (SNS) application, an application with a bulletin board function, and an application with a search function.

3. The method of claim 1, wherein the displaying of the advertisement comprises displaying the advertisement in a popup form on an upper portion of a display region of the user application displayed on the display unit of the user terminal.

4. The method of claim 1, wherein the information containing the keyword is an input value which is input in real time through the input function provided from the operating system of the user terminal.

5. The method of claim 1, wherein the analyzing of the keyword comprises analyzing a product or a service related to the keyword.

6. The method of claim 1, wherein the analyzing of the keyword comprises further analyzing at least one among a user's location, sex, and age, and time zones and seasons when the user uses the user terminal.

7. The method of claim 1, wherein the determining of the advertisement comprises determining an advertisement by matching a product or a service analyzed in the analyzing of the keyword with at least one advertisement stored in the application server or the advertisement providing server.

8. The method of claim 7, wherein the determining of the advertisement comprises determining a plurality of advertisements assigned priority.

9. The method of claim 3, wherein in the displaying of the advertisement, location of the displayed advertisement is variable, and the advertisement is displayed in a blank space of the display region of the user application on the display unit of the user terminal.

10. The method of claim 9, wherein, in the displaying of the advertisement, if the advertisement disappears from the display region of the display unit when a screen is scrolled by a user through the display unit, the advertisement is displayed again within the display region of the display unit.

11. The method of claim 1, wherein, in the displaying of the advertisement, the advertisement is a hyperlinked text or image, wherein, when the text or image is selected by a user, a hyperlinked web page or a multimedia content is displayed.

12. The method of claim 11, wherein the displaying of the advertisement comprises displaying in the advertisement an amount of points to be saved for a user by an advertiser or an advertisement provider, wherein the points are available to exchange for a desired object in an offline or online site, and the method further comprising saving the points by transmitting information that the user satisfies a point saving condition to the advertisement providing server through the advertisement application when the user selects the advertisement assigned the points and views a web page linked to the advertisement or information regarding a displayed multimedia content for a predetermined time or more.

13. The method of claim 1, wherein, when in the determining of the advertisement, advertisements determined based on information which contains a keyword and is input by a user within a predetermined time are the same, the displaying of the advertisement is skipped.

14. The method of claim 12, wherein the saving of the points is skipped when advertisements determined based on information which contains a keyword and is input by a user within a predetermined time are the same in the determining of the advertisement.

15. The method of claim 12, wherein an advertisement assigned lower priority is displayed when advertisements determined based on information which contains a keyword and is input by a user within a predetermined time are the same in the determining of the advertisement.

16. The method of claim 1, wherein, when the advertisement displayed in the displaying of the advertisement is touched by a user, selection mode icons are displayed, wherein the selection mode icons comprises: an icon for directly accessing a hyperlinked homepage; an icon for ending the user application and accessing the hyperlinked homepage; and an icon for adding the hyperlinked homepage to a favorites list of a web surfing user application installed in the user terminal.

17. The method of claim 1, wherein advertisements displayed in the displaying of the advertisement are accumulatively stored in a favorites list of a web surfing application installed in the user terminal or an advertisement storage box of the advertisement application.
